(19) United States
(12) Patent Application Publication
(10) Pub. No.: US 2002/0195796 A1
(43) Pub. Date: Dec. 26, 2002

(54) Coupling system for coupling a trailer to a bicycle

(76) Inventor: Kees De Vogel, AA Oosterwolde (NL)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/886,250

(22) Filed: Jun. 22, 2001

(51) Int. Cl. B60D 1/14; B62K 27/00

(52) U.S. Cl. 280/504; 280/204

(57) ABSTRACT

A coupling system for coupling a trailer to a bicycle, where the first coupling part is mounted near a trailing axle of the bicycle and a second coupling part is mounted to a connecting rod, which in turn is mounted to the trailer. The first coupling part is provided with a spherical hinge part and the second coupling part with a catch lock, which partly embraces the spherical hinge part. The advantage is that the trailer will not overturn when the bicycle overturns.

### BACKGROUND OF THE INVENTION

The invention relates to a system for coupling a trailer to a bicycle, of which a first coupling part can be mounted near a trailing axle of the bicycle and a second coupling part can be mounted on a connecting rod of the trailer.

Systems of this type are well known in the art. The problem with these existing systems is that when, unexpected, the bicycle overturns, the trailer sometimes is dragged along and overturns as well. Especially when the trailer is used for transporting young children, this may have serious consequences.

### SUMMARY OF THE INVENTION

The inventive system substantially obviates this problem and is characterized in that the first coupling part is provided with an at least substantially spherical hinge part and the second coupling part is provided with a catch lock which under operational conditions embraces the spherical hinge part. The inventive system is based upon the observation that when a bicycle overturns, it tends to rotate round its longitudinal axis, which substantially coincides with the two axles of the wheels. By locating the spherical hinge part on this imaginary axis, the bicycle may overturn while the spherical hinge part rotates unhindered inside the catch lock.

A very favourable embodiment according to a further aspect of the invention is based upon the observation that the catch lock and the connecting rod connected to it should be permitted to swing freely in a horizontal plane, in order to prevent torsional stress in the coupling system when the combination of the trailer and the bicycle make a relatively sharp turn. This embodiment is characterized in that the catch lock is arranged such as to contact under operational conditions at least substantially the upper side and the lower side of the spherical hinge part.

Another very favourable embodiment is characterized in that the catch lock is asymmetrically shaped, such that under operational conditions an angle of thirty to sixty degrees is realized between a longitudinal axis of the bicycle and a longitudinal axis of the connecting rod. A favourable choice is forty-five degrees, because on the one side there is little chance that the connecting rod will hit the bicycle when a sharp turn is made, while on the other side the total width of the combination does not become excessive.

Another favourable embodiment, which provides for an easy uncoupling of the system, is characterized in that the catch lock comprises a first and a second catch lock half, the first catch lock half having a first cup shaped cavity and the second catch lock half having a second cup shaped cavity, of which under operational conditions the first cup shaped cavity embraces the upper side of the spherical hinge part and the second cup shaped cavity embraces the lower side of the spherical hinge part. A favourable realization is characterized in that the catch lock halves are mutually rotatable connected and that in at least one catch lock half a recess is made for letting pass the spherical hinge part. Preferably the connecting rod is mounted to the first catch lock half and the recess is also made in the first catch lock half.

A favourable embodiment, which prevents the unintentional uncoupling of the coupling system in a very simple way, is characterized in that the system moreover comprises a locking pin which can be placed into a hole, penetrating both catch lock halves.

Another favourable embodiment, which prevents the unauthorized uncoupling of the coupling system, is characterized in that the system moreover comprises a lock, for mutually arresting both catch lock halves.

Still another favourable embodiment of the inventive coupling system is characterized in that the first coupling part comprises a mounting bracket, a rod-shaped part connected to the mounting bracket and the spherical hinge part connected to the rod-shaped part. The rod-shaped part shall preferably be oriented such that it can be mounted parallel to a longitudinal axis of the bicycle, for realizing an optimal freedom of movement.

The invention also relates to a first coupling part or a second coupling part, adapted to be used in a system as disclosed.

### BRIEF DESCRIPTION OF THE DRAWINGS

The invention will now be further explained with a reference to the following figures, in which:

FIG. 1 represents in side view a possible embodiment of a first coupling part;

FIG. 2 represents in side view a possible embodiment of a second coupling part;

FIG. 3 represents in top view a lower catch lock half of the second coupling part.

### DETAILED DESCRIPTION OF THE INVENTION

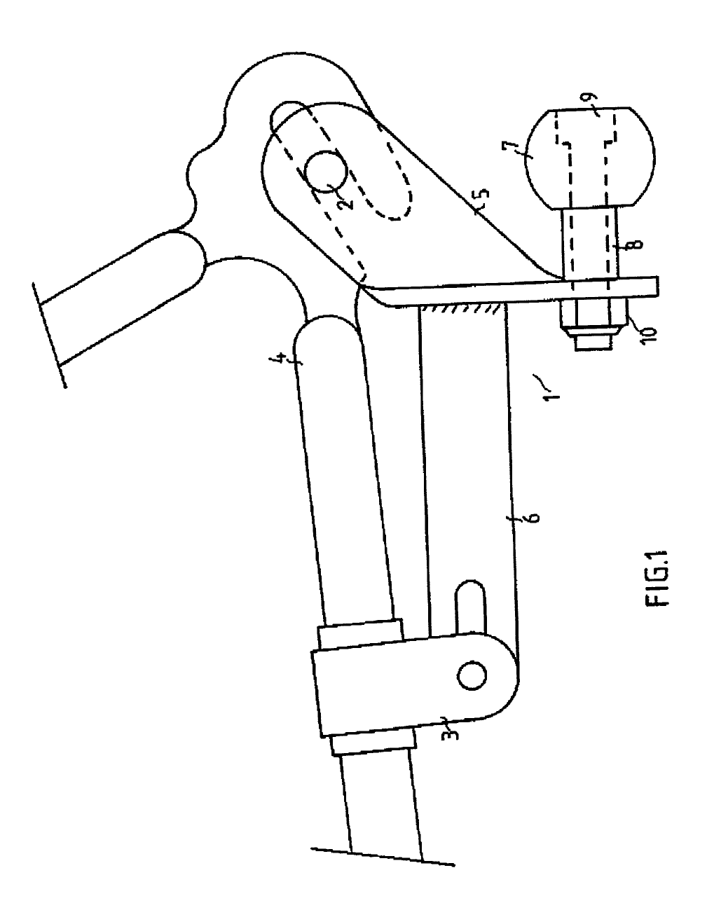

FIG. 1 represents in side view a possible embodiment of a first coupling part, of which a mounting bracket 1 is connected to a trailing axle 2 of a bicycle and via a securing strap 3 to a frame 4 of the bicycle. Mounting bracket 1 comprises a part 5, bent to 90 degrees, to which a strip shaped part 6 is welded. Onto bent part 5, a substantially spherical hinge part 7 is mounted, via a rod-shaped part 8. Spherical hinge part 7 and rod-shaped part 8 both are drilled through and into the boring a bolt is placed and fixed with a self-locking nut 10. The first coupling part is easily mounted and the two separate mounting means guarantee a sturdy and redundant attachment. Being mounted in this way, a longitudinal axis of bolt 9 is positioned such that, if the bicycle would unexpected overturn, it would almost certain rotate around this longitudinal axis, in such a manner that the spherical hinge part 7 would rotate, but hardly translate.

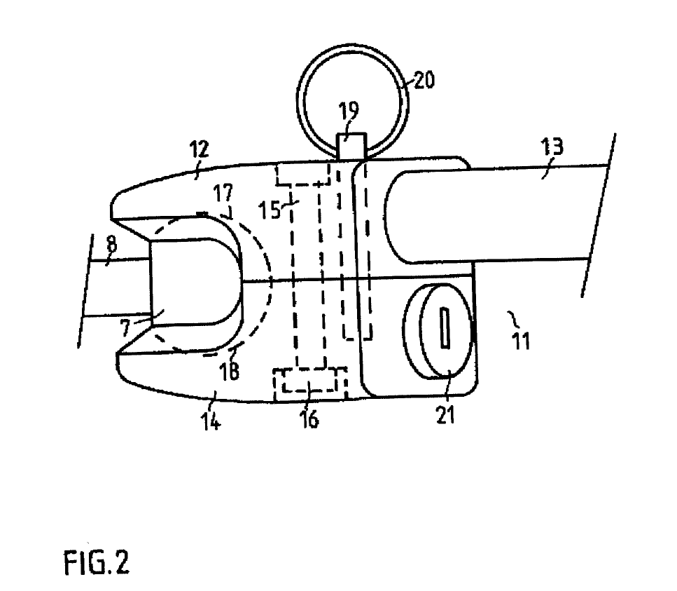

FIG. 2 represents in side view a possible embodiment of a second coupling part, with a catch lock 11, consisting of an upper catch lock half 12, to which a connecting rod 13 is mounted which is connected to a trailer, not shown. Preferably, the upper catch lock half 12 is provided with a projection, over which connecting rod 13 can be slid and fixed with a bolt and nut. The advantage is that a visual inspection can easily be made.

Lower catch lock half 14 is mounted to upper catch lock half 12 and may rotate around an axle 15, consisting of a bolt and a self-locking nut 16 which is mounted in a recess in lower catch lock half 14. Catch lock half 12 is provided with a cup shaped cavity 17 and catch lock half 14 with a cup shaped cavity 18, between which spherical hinge part 7 is retained. Cup shaped cavities 17, 18 and spherical hinge part 7 together form a ball fitting, as such well known in the art, which guarantees an optimal mobility in all directions, while in this specific embodiment especially an optimal mobility is guaranteed in a plane which coincides with a joint face of both catch lock halves 12, 14.

Lower catch lock half 14 is provided with a recess, not visible in the figure, such that if lower catch lock half 14 is rotated round axle 15, the spherical hinge part 7 is set free and the system is disengaged. In order to prevent an unintentional disengagement, a locking pin 19 is provided, which can be inserted in a boring in both catch lock halves 12, 14, preventing catch lock half 14 from rotating with respect to catch lock half 12. Disengagement of the system is possible by removing locking pin 19 beforehand, for example by pulling ring 20. Alternatively, locking pin 19 may be mounted spring loaded, in which case disengagement is possible by slightly lifting locking pin 19 against the spring force. In order to prevent the trailer from being removed by an unauthorized person, catch lock 11 may moreover be provided with a lock 21, of which a pawl, not visible, can be rotated such that it will protrude out and prevent both catch lock halves 12, 14 from mutually rotating.

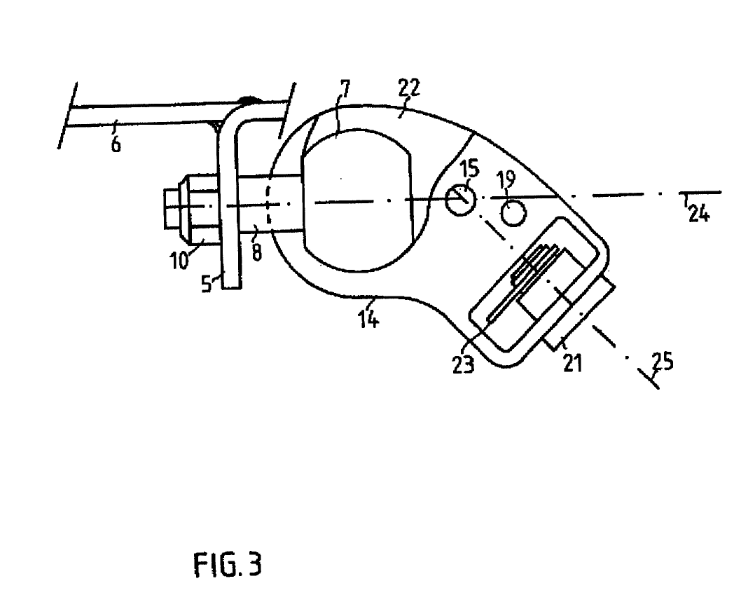

FIG. 3 represents in top view a lower catch lock half of the second coupling part, with the upper catch lock half 12 being removed in order to clarify the operation of the coupling. Visible now is spherical hinge part 7, which is positioned in lower catch lock half 14, and a recess 22 which is in fact united with the cup shaped cavity 18, not visible, which embraces the lower part of spherical hinge part 7. Recess 22 is shaped in such a manner that lower catch lock half 14 may rotate around axle 15, away from spherical hinge part 7, while spherical hinge part 7 remains in place. Visible also is the boring into which locking pin 19 can be placed, via upper catch lock half 12 which has been removed here, in order to prevent both catch lock halves from mutually rotating. Moreover a pawl 23 is visible, which can be rotated upwards by operating lock 21, such that it protrudes into a small recess in upper catch lock half 12 and prevents catch lock half 14 from rotating away.

Moreover a first centre line 24 shows the direction of the longitudinal axis of the bicycle and a second centre line 25 shows the direction of connecting rod 13. The angle between both centre lines is 45 degrees if the bicycle moves straight on and will decrease when a right turn is made.

Catch lock halves 12, 14 each are made in a manner well known in the art, of a synthetic material, for example in an injection moulding process preferably reinforced with glass fiber, or of aluminium.

1. A system for coupling a trailer to a bicycle, of which a first coupling part can be mounted near a trailing axle of the bicycle and a second coupling part can be mounted on a connecting rod of the trailer, characterized in that the first coupling part is provided with an at least substantially spherical hinge part and the second coupling part is provided with a catch lock which under operational conditions embraces the spherical hinge part.

2. A system according to claim 1, characterized in that the catch lock is arranged such as to contact under operational conditions at least substantially the upper side and the lower side of the spherical hinge part.

3. A system according to claim 1, characterized in that the catch lock is asymmetrically shaped, such that under operational conditions an angle of thirty to sixty degrees is realized between a longitudinal axis of the bicycle and a longitudinal axis of the connecting rod.

4. A system according to claim 2, characterized in that the catch lock comprises a first and a second catch lock half, the first catch lock half having a first cup shaped cavity and the second catch lock half having a second cup shaped cavity, of which under operational conditions the first cup shaped cavity embraces the upper side of the spherical hinge part and the second cup shaped cavity embraces the lower side of the spherical hinge part.

5. A system according to claim 4, characterized in that the catch lock halves are mutually rotatable connected and that in at least one catch lock half a recess is made for letting pass the spherical hinge part.

6. A system according to claim 5, characterized in that the connecting rod is mounted to the first catch lock half and that in the first catch lock half the recess is made.

7. A system according to claim 5, characterized in that the system moreover comprises a locking pin, which can be placed into a hole, penetrating both catch lock halves.

8. A system according to claim 5, characterized in that the system moreover comprises a lock, for mutually arresting both catch lock halves.

9. A system according to claim 1, characterized in that the first coupling part comprises a mounting bracket, a rod-shaped part connected to the mounting bracket and the spherical hinge part connected to the rod-shaped part.

10. A first coupling part or second coupling part adapted to be used in a system as claimed in one of the previous claims.
